(19) United States
(12) Patent Application Publication
(10) Pub. No.: US 2007/0119970 A1
(43) Pub. Date: May 31, 2007

(54) Method to fog and mist dispersion and related apparatus description

(76) Inventors: Valerio Abate, Saronno (IT); Alberto Conti, Milano (IT); Michaela Bianchi, Milano (IT)

Correspondence Address: DICKSTEIN SHAPIRO LLP, 1825 EYE STREET NW, Washington, DC, 20006-5403, US

(21) Appl. No.: 10/580,817

(22) PCT Filed: Nov. 28, 2003
(86) PCT No.: PCT/IT03/00786

§ 371 Date: May 26, 2006

(51) Int. Cl. B05B 1/08

(52) U.S. Cl. 239/102.2; 239/102.1; 239/2.1

(57) ABSTRACT

The present invention relates to a method for coagulation and dispersion of fog and an installation thereof, in particular a system for fog dispersal over automobile roads, highways, roundabouts, and rail roads. The process produces fog or mist particle coagulation using fields of sonic, ultrasonic or electromagnetic waves generated with a power density level and then projected to a selected area of an open space where they produce forces on particles and then movement of abovementioned particles, said movement producing coagulation and further aggregation.

### TECHNICAL FIELD

The present invention relates to a method for coagulation and dispersion of fog and an installation thereof, in particular a system for fog dispersal over automobile roads, highways, roundabouts, and rail roads.

### BACKGROUND ART

The fog is a suspension of numerous very small (average diameter some micron) alternate corpuscles of water or crystals of ice in an atmosphere, or even frequently non water particle are mixed especially over roads, highways etc. The nature of these non-water particles is powders from combustion or tires, chemicals etc. etc. all deriving from vehicles system interaction. The fog restricts a transparency of an atmosphere. Depending on distance of visibility fogs are divided on:
Dense fog distance of visibility of 50-200 m.;
Usual fog-distance of visibility of 200-500 m.;
Easy fog-distance of visibility of 500-1000 m.

The fogs are generated and disperse or move in an atmosphere at definite level of humidity and temperature. A special role in originating of fogs is played always with aerosol corpuscles, present in an atmosphere. These corpuscles present in air can form as condensation nucleus water drops from fogs. The fog coagulates on this nucleus.

Depending on temperature of enclosing atmospheric air the fogs are divided on warm fogs and cold fogs. The cold fogs consist of the drops of water at temperature around zero degrees Celsius. Such fogs are the easiest to disperse: even if they are stable colloids, their thermodynamic state is in a potential meta-stable condition. In such conditions any variation of pressure conditions small variation of temperature or particle mass will produce easily precipitation.

The mechanism is known in literature since at same temperature the pressure of saturated vapor (i.e. fogs) in presence of ice (solid state) is less than the pressure of saturated vapor in presence of liquid surface. Introducing an iced surface in form of ice crystals or even icing of the road the drops of water to evaporate. The evaporated moisture condensate and ices on ice crystals and iced surface. Ice crystals grow in dimensions since they reach critical mass and start falling. The system could be applied through spraying of liquid nitrogen or fine carbon dioxide (dry ice).

The warm fogs are even colloid but they are thermodynamically stable. Any practical approach to disperse warm fog in literature is not well documented.

In US5655383 a thermal field is produced, that cool air. The system dry air and it is sprayed in a predefined area producing stirring with existing fog and diluting its effect.

In US4781326 a method is disclosed in which high-pressure water is pumped through nozzles that sprays droplet. The droplets fall in the fog colliding and collecting fog and particles. The method requires pipes and water that are very easy to be found and laid in airport or in cities but are difficult to install on long highway etc. The reuse of water in case of long roads is more difficult than in case of runways and cities.

In US6152378 a corona discharge is used to precipitate fog.

The corona effect is produced in wires and it ionises air or particles. The effects of ions are to collect water and other particle due to the polar nature of such particles. The particle grows and by moving initially along electric field lines start to growth until the gravitational force prevails producing the precipitation. The system requires installation of suspended wires along roads and the precipitation is related to electric field lines behaviour that could be unexpected due to installation/plants electric pipelines near the roads. Further disadvantage there is a problem that, the device is not directional producing low volumetric efficiency in dispersion of fogs.

It is noted by the author that the conceptual problems to be solved in dissolving fogs are two:

The initiating problem is to produce an aggregation of water and non-water particles with sufficient dimension to start falling;

The displacing problem is to produce movement of water/particles to clean air by aggregation and collection.

The present invention is intended to resolve the above-described technical problems, and in order to produce fogs coagulation within a predefined area in an open environment, and maintain the effect of fog coagulation in that area.

The open environment is defined as an area were the motion of fog and mist is unbounded by surrounding walls or systems, or when the boundary are far from the predefined area that their influences on mist and fog motion could be neglected.

In US5085783 A methods is disclosed separate particles from a suspension. However, none of them offer sufficient separation efficiency for fine (on the order of 1 micron) particles. In this a suspension is fed into a cylinder. Acoustic waves are sent into each end of the cylinder. The sum of the acoustic waves causes cavitations in the suspension. Strong pressure pulses drive particles to the centre of the cylinder, where they can be removed. This region is a confined region and it is difficult to use in real applications.

In US4462483 an invention is disclosed to increase visual range in visible and infrared and clearness of air. The proposed solution is to remove fume, mist, and smoke-screen to improve vision. A powerful ultrasound generator is used to coagulate particles suspended in air. The ultrasonic coagulation is a merger of small solid particles suspended in a liquid, due to acoustic vibrations. The main problem is to produce a source of high intensity ultrasound and the solution using explosives is dangerous and difficult to use along roads. An other disadvantage of this solution is that it requires a recharging of explosives and produces dangerous sounds level.

### DETAILED DESCRIPTION OF THE PRESENT INVENTION

The present invention discloses a method using standing waves to produce fog particles coagulation. Some apparatuses are also described able to produce coagulation in defined areas of unbounded volume.

The standing waves as proposed could be of two types depending on the particle to be coagulated: or vibrations i.e. mechanical waves and electric or RF Waves.

In case of acoustic the mass and volume of particle are used to produce movements, in case of radiofrequency it is needed that particles be charged somehow for example by a ionizer or a friction device.

According to experience and described physical phenomenon at the beginning of irradiation, almost instantaneously the particles are driven towards the wave nodes planes, whereby the average distance between the particles considerably diminishes. Then the particles trapped within the planes migrate closer together, whereby coagulation and even coalescence may be triggered.

The phenomenon is applicable to all kinds of dispersions. The particles can be gaseous, liquid, or solid. The dispersion fluid can be gaseous or liquid, preferably air for the purpose of present invention. The most important practical examples are particles of all kinds in air (aerosols). This applicability on all possible kinds of dispersions indicates the great potential of the ultrasonic separation. Nevertheless, the phenomenon has not yet gained widespread industrial application, as the process can be highly sensitive to disturbances and involves acoustic forces that have to be compared with the separation speed limiting viscous drag forces. However, with nowadays available highly advanced piezoelectric transducers and driving electronics it is possible to construct high power sources that concentrates the emissions in area were it is needed directly by shape, wave emission control or focalization devices. Nevertheless it is possible with nowadays technology to produce focusing system such as sonic or ultrasonic lenses to reach the required area power intensity.

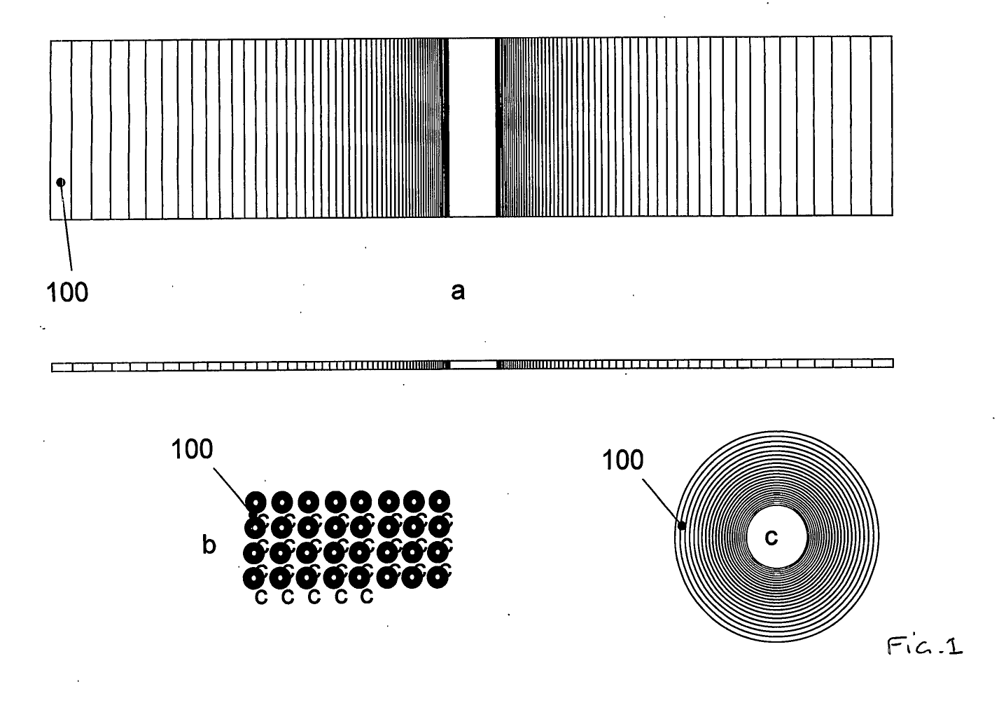

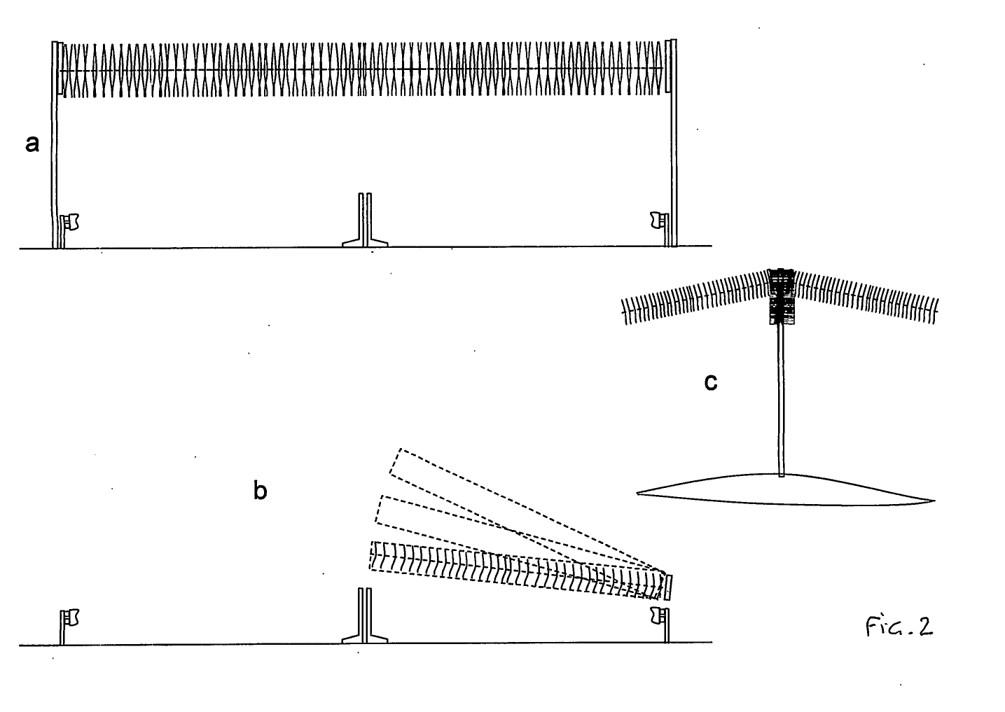

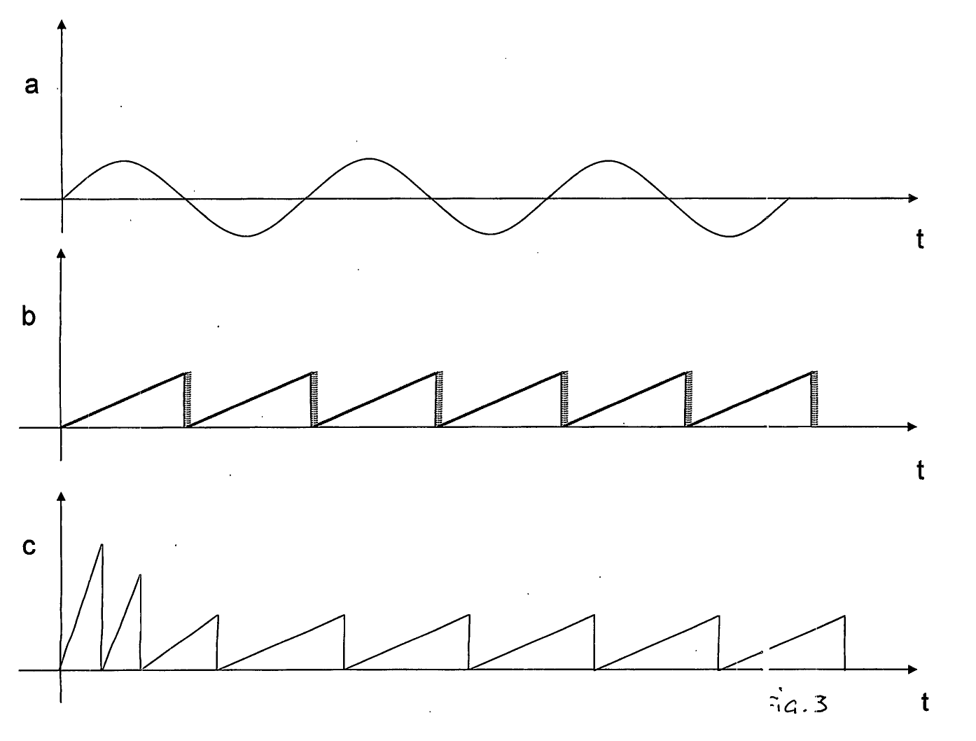

One preferred embodiment of present solution is a piezoelectric or traditional sound source with multiple elements or vibrators according to FIG. 1a, b, c, producing a series of waves. The vibrators could be of piezoelectric nature, membrane in resonance or electromagnetic. The shape of emitter series in the source have different shaping according to the desired result of area to be covered by the field. The wave's frequency could range from 500-600 Hz to 1 MHz, their frequency is chosen according to fog characteristics, the type of coagulation phenomenon to excited, the desired area to be “cleaned” and the time to clean and the available power at source. In special application the chosen range is 1-20 KHz, this could be useful depending of fog type. Each emitter (100) is controlled via an electronic circuitry that regulates wave's emission in order to produce waves with predefined shape (see FIG. 2a, b, c) and delays (see FIG. 3 b). The delay is studied in order to produce in a defined area and on a defined length:
The condensing and coagulation of small water drops due to intensity and concentration of waves,
The movement of particles/drops subjects to three basic forces according to following description.

Specifically to background documentation three forces are used that dominates the system behaviour. A radiation force F₁ moves the particles into the anti-node planes of the acoustic displacement velocity whereas a Bernoulli force F₂ moves the particles along lateral amplitude gradients of the displacement velocity and causes the particles to form columns perpendicular to the transducer. At this point a radiation force F₃ is caused by the scattered sonic field of a particle and causes nearby particles to coagulate.

The last force could be also generated not only by scattered field but by a proper wave composition and shaping in time.

In the preferred embodiment of the present invention a shown in FIG. 3a) of the present invention is realized by imposing a standing waves area above the road or an area of concentrated controlled field. In this configuration water droplet are generated near the emitter and are then shifted collecting vapour and other small drops. The type of wave excitation shifts the droplets in accumulation area where they reach the dimension to start falling on the road.

The standing wave area is a region of high concentrated sound wave emission (100-1000 W/mˆ2) usually in the range of few meters. The composition of a series of generated waves in such a manner to produce negative composition in all the region surrounding the coagulation area and a positive composition in the region identified to produce coagulation. Using proper waves such as Gauss or Bessel beams it is possible to generate very intense and limited are in which the field is limited by itself without any boundary.

An other preferred embodiment of the present invention the emitter is tilted with the field switched on from a top to a bottom position (see FIG. 2b) producing the growth of water droplets according to previous describe mechanism and scanning the area above the road.

An other preferred embodiment of present invention specially adapted for roundabout allows to suspend emitter at the central position of the roundabout and to rotate slowly it. It is possible to shape the emitter to produce an axial shaped field in order to avoid rotating the emitter itself.

An other preferred embodiment of present invention specially adapted for the coagulation around a charged particle and the concentration and movement induced by the field thereof.

### OTHER REFERENCES

Kundt und Lehmann (“Longitudinal vibrations and acoustic figures in cylindrical columns of liquids,” Annalen der Physik und Chemie (Poggendorff's Annalen), vol. 153, pp. 1, 1874.)

L. A. Crum, “Acoustic force on a liquid droplet in an acoustic stationary wave,” J. Acoust. Soc. Am., vol. 50, pp. 157-163, 1971.

T. L. Tolt and D. L. Feke, “Separation of dispersed phases from liquids in acoustically driven chambers,” Chem. Eng. Sci., vol. 48, pp. 527-540, 1993.

E. Riera-Franco de Sarabia, J. A. Gallego-Juárez, G. Rodríguez-Corral, L. Elvira-Segura, and I. González-Gómez, “Application of high-power ultrasound to enhance fluid/solid particle separation processes,” Ultrasonics, vol. 38, pp. 642-646, 2000.

L. P. Gor'kov, “On the forces acting on a small particle in an acoustical field in an ideal fluid,” Sov. Phys. Dokl., vol. 6, pp. 773-775, 1962.

S. M. Woodside, J. M. Piret, M. Gröschl, E. Benes, and B. D. Bowen, “Acoustic force distribution in resonators for ultrasonic particle separation,” AIChE Journal, vol. 44, pp. 1976-1984, 1998.

1. Method to produce fog or mist particle coagulation comprising the steps of generate sonic or electromagnetic waves to a first power density said waves generatings forces on said particles characterized on that said waves are static waves generated in a selected area of an open space.

2. Method to produce particle coagulation according to claim 1 characterized on that it also comprise the step of concentrating the waves in the selected area by a focusing device to a second power density beeing said second power density higher than said first power density.

3. Method to produce particle coagulation according to claim 1 characterized on that it also comprise the step of generating nucleating particles for moving said particles in order to
moving said nucleating particles by said forces inside the area,
increasing dimension of said nucleating particles by collecting the particles during their movement.

4. Method to produce particle coagulation according to claim 1 characterized on that it also comprise the step of generating charged particles for
moving said charged particles by electromagnetic field in said area,
increasing dimension by collecting said particles particles during their movement,
Apparathus for producing fog or mist particle coagulation comprising means for generate sonic or electromagnetic waves to a first power density said waves gene ratings forces on said particles characterized on that said waves are static waves generated in a selected area of an open space

5. Apparathus for producing particle coagulation comprising means for generating sonic or electromagnetic static waves characterized on that it also comprise means for generating large dimension nucleating particles, means for reducing distance between said particles and said charged or/and nucleating particles,
a transducer for moving said particles and said charged or/and nucleating particles in a selected area of an open space via excitation of mass characteristics,

6. Apparathus for producing particle according to claim 4 characterized on that it also comprise means for generating large dimension charged particles, a transducer for moving said particles and said charged or/and nucleating particles in a selected area of an open space via excitation of mass characteristics,

7. Apparathus for to produce particle coagulation according to claim 4 characterized on that it also comprise means for tilting and/or moving the coagulation area.

8. Apparathus for to produce particle coagulation according to claim 4 characterized on that said means for generating sonic static waves are at least one piezoelectric element.

9. Apparathus for to produce particle coagulation according to claim 7 characterized on that said at least one piezoelectric element has a shaped variable surface

10. Apparathus for to produce particle coagulation according to claim 7 characterized on that said at least one piezoelectric element has a thickness variable surface
